(19) United States
(12) Patent Application Publication
(10) Pub. No.: US 2024/0198438 A1
(43) Pub. Date: Jun. 20, 2024

(54) REMOTELY CONTROLLED CUTTING TOOL AND METHOD

(71) Applicant: Huskie Tools, LLC, Addison, IL (US)

(72) Inventors: Nicholas Skrobot, Addison, IL (US); Dan Voss, Addison, IL (US)

(21) Appl. No.: 18/588,997

(22) Filed: Feb. 27, 2024

Related U.S. Application Data
(63) Continuation of application No. 17/296,111, filed on May 21, 2021.
(60) Provisional application No. 62/906,264, filed on Sep. 26, 2019.

(51) Int. Cl. B23D 29/00; H02G 1/12

(52) U.S. Cl. CPC B23D 29/002; H02G 1/1214

(57) ABSTRACT

A remotely controlled cutting tool for safely cutting electrified cables using a remote control and a method of setting up and operating the remotely controlled cutting tool and remote control.

### CROSS REFERENCE TO RELATED APPLICATIONS

This application is a continuation of and claims priority benefit to U.S. patent application Ser. No. 17/296,111, filed on May 21, 2021, which traces priority to Patent Cooperation Treaty (PCT) application number PCT/US2020/053131 filed Sep. 28, 2020 and U.S. Provisional Patent Application No. 62/906,264 filed Sep. 26, 2019, titled REMOTELY CONTROLLED CUTTING TOOL AND METHOD, the entire contents of each of which are hereby expressly incorporated by reference.

### TECHNICAL FIELD AND BACKGROUND OF THE INVENTION

The present invention relates to the field of cable cutting in the electrical industry, particularly to tools used by utility linemen and professional electricians to cut electrically conductive cable. The present invention includes a cutting tool that provides safety features to reduce risk of injury to the operator.

Traditional handheld cutting tools are used by linemen and professional electricians to cut cables during installation, upgrading, and routine maintenance. Electrified cables pose a risk of injury to operators as electrical current may pass through a handheld device to the hand of the operator. There is a need for a cable cutting tool capable of being safely controlled from a distance.

### BRIEF SUMMARY OF THE INVENTION

It is therefore an object of the present invention to provide a remotely controlled cutting tool capable of cutting cable that does not require physical contact during operation.

It is another object of the present invention to provide a remotely controlled cutting tool which does not have an activation trigger on the cutting tool.

According to an aspect of the invention a remotely controlled cutting tool includes a stationary blade, a moving blade having an arched outer perimeter including a plurality of teeth, a rotatable connection between the stationary plate and the moving blade, a mechanical gear drive for engaging with the plurality of teeth on the moving blade to rotate the moving blade about the rotatable connection, and a remote control adapted to remotely activate the mechanical gear drive.

According to another embodiment of the invention, the tool does not have an activation trigger for the mechanical gear drive and only the remote control is adapted to activate the tool.

According to another embodiment of the invention, a positive latch is connected to the moving blade and adapted to engage with the mechanical gear drive to position the moving blade in a predetermined position.

According to another embodiment of the invention, a sensor is adapted to detect moving blade position.

According to another embodiment of the invention, the tool includes indicators for blade position, power setting, and battery charge.

According to another embodiment of the invention, the tool and the remote control are exclusively paired.

According to another embodiment of the invention, an adjustable grounding stud is positioned on the rotatable connection between the stationary blade and the moving blade.

According to another embodiment of the invention, rigging and accessory attachment means are provided.

According to another embodiment of the invention, controls for the tool and the remote control are backlit.

According to another embodiment of the invention, a method for operating a remotely controlled cutting tool includes the steps of positioning a cable between a stationary blade and a moving blade of a remotely controlled cutting tool, engaging the moving blade with a mechanical gear drive, and cutting the cable by activating the mechanical gear from a distance with a remote control.

According to another embodiment of the invention, the positioning of the tool around the cable prevents damage to adjacent cables.

According to another embodiment of the invention, a grounding stud is connected to the tool for providing grounding to the stationary and moving blades during operation of the tool.

According to another embodiment of the invention, the tool is securely positioned with rigging connected to rigging points on the tool.

According to another embodiment of the invention, the tool does not have an activation trigger and activation can only occur by activation triggers on the remote control.

According to another embodiment of the invention, indicators on the remote control are adapted to provide feedback on the status of the cut.

### BRIEF DESCRIPTION OF THE DRAWINGS

Features, aspects and advantages of the present invention are understood when the following detailed description of the invention is read with reference to the accompanying drawings, in which:

FIG. 1 is a perspective view of a remotely controlled cutting tool;

FIG. 2 is a front view of the remotely controlled cutting tool in FIG. 1;

FIG. 3 is a right side view of the remotely controlled cutting tool in FIG. 1;

FIG. 4 is a left side view of the remotely controlled cutting tool in FIG. 1;

FIG. 5 is a partial perspective view of the remotely controlled cutting tool in FIG. 1;

FIG. 6 is a partial perspective view of the remotely controlled cutting tool in FIG. 1;

FIG. 7 is a partial perspective view of the remotely controlled cutting tool in FIG. 1;

FIG. 8 is a perspective view of the remotely controlled cutting tool in FIG. 1 having a battery installed;

FIG. 9 is a perspective view of the remotely controlled cutting tool in FIG. 1 having a grounding stud installed;

FIG. 10 is a perspective view of a remote control for use with the remotely controlled cutting tool in FIG. 1; and

FIG. 11 is a front view of the remote control in FIG. 10.

### DETAILED DESCRIPTION OF THE INVENTION

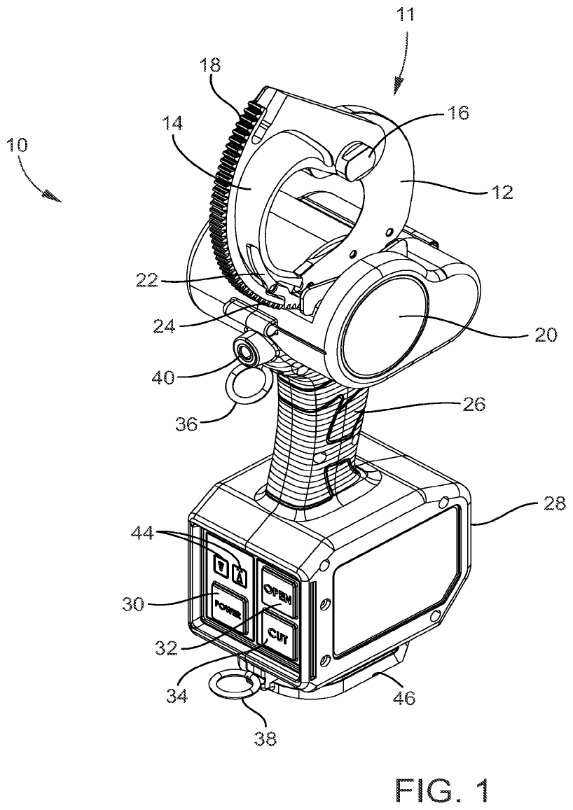

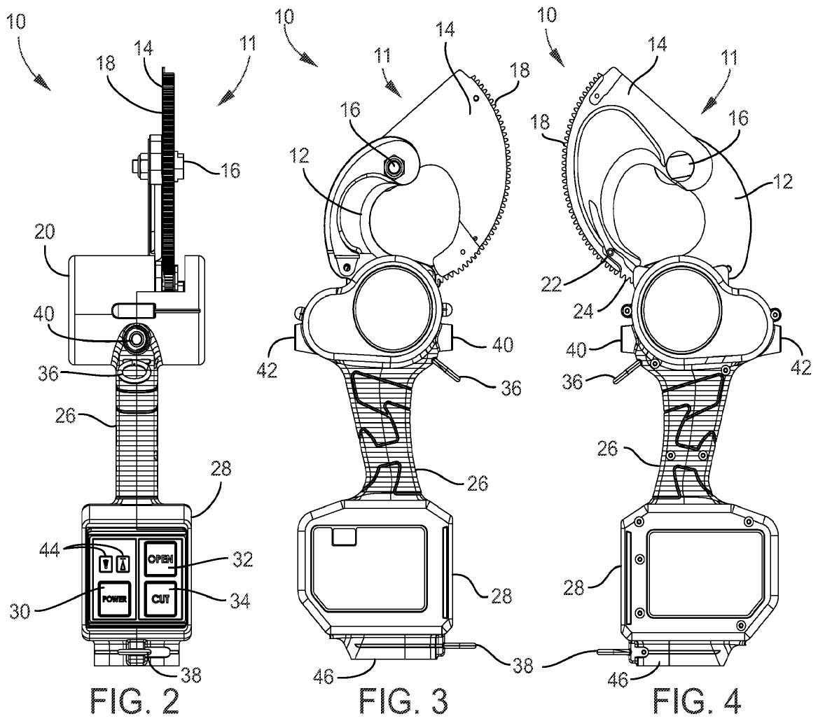

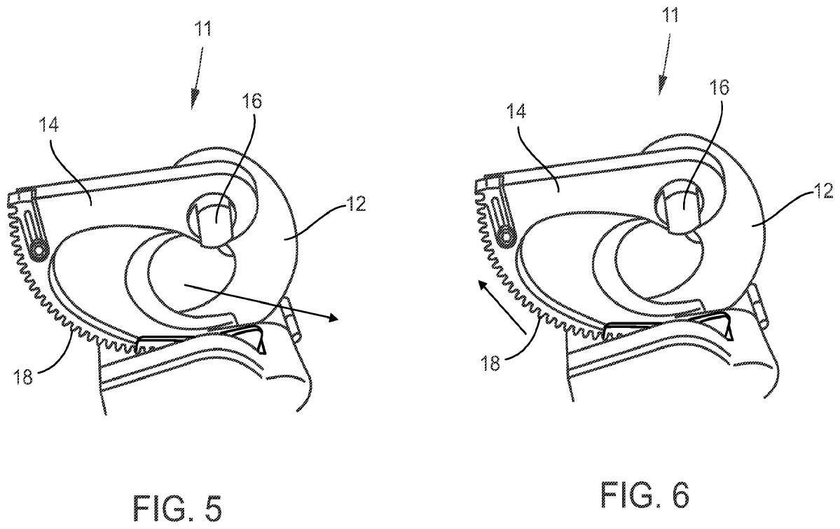

Referring now to FIGS. 1-6, a remotely controlled cutting tool 10 is shown. The tool 10 has a jaw 11 which includes a stationary blade 12 and a moving blade 14 which pivots around a bolted pivoting connection 16. A plurality of teeth 18 are positioned around a portion of the outer circumference of the moving blade 14. The teeth engage with a gear, or drive mechanism, (not shown) contained within a gear housing 20. Rotation of the gear within the gear housing 20 causes the moving blade 14 to either move closer to or further away from the stationary blade 12 for cutting purposes or opening purposes. The inside circumference, or edges, of the blades 12, 14 are sharpened such that they are able to cut through cable as the moving blade 14 pivots toward the stationary blade 12. This cutting motion can be seen is FIG. 5. The releasing, or opening, motion is likewise shown in FIG. 6.

A positive blade engagement latch 22 is connected to an end of the moving blade 14. The latch 22 has a set of teeth 24 that enable the operator to positively engage with the drive mechanism to hold the moving blade 14 in a desired position to ensure correct setup and positioning. This latch 22 and teeth 24 combination enables an operator to position a cable between the blades 12, 14 and secure the moving blade 14. Cables of various sizes require the moving blade 14 to be positioned relative the stationary blade 12 such that the opening between the sharpened edges are able to accommodate the various cable sizes.

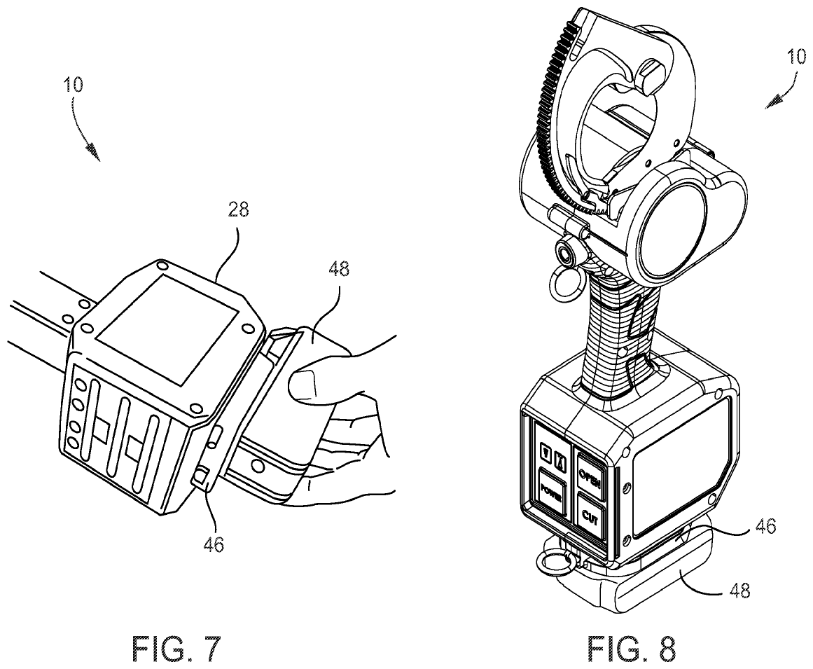

A handle 26 is positioned between the gear housing 20 and a motor housing 28. As shown in FIGS. 7 and 8, a battery connector 46 is located on the motor housing 28 enabling the operator to attach a battery 48 to the tool 10. One example of a battery 48 is a 18V slide-on battery. The motor housing 28 has a control button 30 for power, a control button 32 for setting the gear into a jaw opening rotation, and a control button 34 for setting the gear into a jaw closing, or cutting, rotation. As a safety feature, the jaw control buttons 32, 34 only put the gear into place for the desired motion and are not capable of activating the tool 10. The tool 10 itself does not have an activation trigger. This safety feature prevents unintended tool 10 activation during setup and removal.

LED indicators 44 on the motor housing 28 provide a simple visual check for the operator prior to leaving the work area. The LED indicators 44 provide good light in low light and high light conditions, such as in underground situations and in direct sunlight situations. Examples of LED indicators 44 include tool 10 power, gear direction (cut or open), successful blade engagement, and successful connection to a remote control 110. A blade engagement sensor (not shown) may monitor the connection between the latch 22 and the gear within the gear housing 20. Upon successful engagement, the LED indicators 44 may show that blade engagement has been successful. Additional indicators may be included such as a successful cut indicator and a jaw 11 fully open indicator.

The gear housing 20 and the motor and battery housing 28 are designed such that minimal space within is wasted while all of the necessary components, such as the mechanicals, electronics, communication module and battery interface are contained within. This design reduces the size and weight of the tool 10. The handle 26 enables the operator to handle the tool 10 one handed while using insulated gloves for tool 10 placement and rigging.

The tool 10 includes two rings, a first ring 36 positioned relatively closer to the jaws 11, and second ring 38 positioned at the base of the motor and battery housing 28. h addition to the rings 36, 38, a first female thread 40 is positioned near the first ring 36 and a second female thread 42 is positioned on an opposite side of the tool 10 as the first female thread. The female threads 40, 42 are ⅜-16 UNC female threads. Various accessories such as straps, handles, rigging, tripods, eyebolts, hoist rings, T's, handles, and the like may be connected to the rings 36, 38 or to the female threads 40, 42.

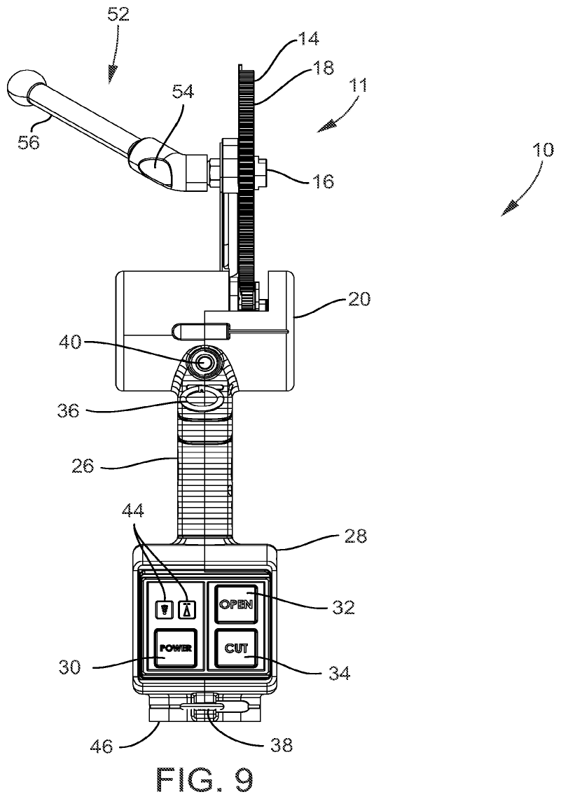

The tool 10 has a grounding stud 52 connected to the pivoting connection 16. The grounding stud 52 allows various types of grounding clamps to be connected to the tool 10 and make electrical connection to the blades 12, 14. As shown in FIG. 9, a ball socket ground stud 52 having a 1″ OD ball 54 and a 4″ long shank 56 are connected directly to the pivot bolt 16. The ball socket ground stud 52 allows for multiple angles of position.

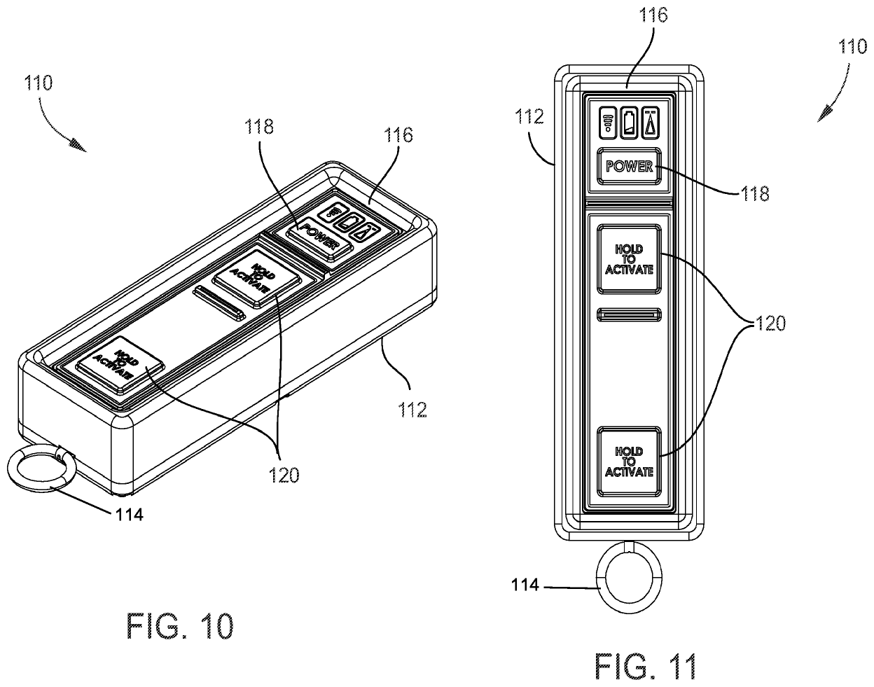

Referring now to FIGS. 10 and 11, a remote control 110 for being paired with a specific tool 10 is shown. The remote control 110 has a housing 112 containing electronics, a battery, and a communication module. The remote control 110 also has a ring 114 positioned on the housing 112. The ring 114 allows for the remote control 110 to include straps, be connected to another device or accessory, be stored connected to the tool 10, and likewise. It is intended that each remote control 110 is adapted to exclusively pair with only one tool 10. For security and safety each tool 10 may only be paired with one remote control 110 at a time. Exclusive pairing increases control and security over tool 10 activation, speed of pairing in the field, and reduces the risk of communication interference and signal interruption. Corresponding serial numbers, or other identifiers, may be included on the tool 10 and the remote control 110 so that the correct tool 10 and remote control 110 can be paired together.

Like the tool 10, the remote control 110 includes several LED indicators 116. These indicators 116 may duplicate the indicators 44 on the tool 10 such as tool 10 power, gear direction (cut or open), successful blade engagement, and successful pairing between the tool 10 and the remote control 110. Additionally other indicators 116 may be included such as remote control 110 power and low battery warning (for the tool 10, remote control 110, or both). Examples of indicators 116, 44 provided may be only on one of the tool 10 or the remote control 110 or on both.

A power on/off button 118 is positioned on the housing 112. The power button 118 primarily turns the power on/off for the remote control 110.

Activation of the tool 10 is only achieved by utilizing the remote control 110 as no activation means exists on the tool 10 itself. Two separate activation buttons 120 are positioned on the remote control 110. These activation buttons 120 are in a spaced-apart relationship. The tool 10 will not activate until both of the activation buttons 120 have been pressed down by the operator. This additional security reduces accidental activation of the tool 10. All or some of the buttons 118, 120 are recessed on the housing 112 to minimize accidental triggering for further safety. The buttons 118, 120 may be switches or other suitable controlling means. An additional safety feature may include automatic stopping on the tool 10 in the event that communication between the tool 10 and the remote control 110 is lost or degraded.

In one embodiment, the remote control 110 may be capable of communicating at a distance of at least 150 feet from the tool 10. Sorting and operating temperatures for both the tool 10 and the remote control 110 may be between −40° F. (−40° C.) to +140° F. (+60° C.).

Operation of the tool 10 by the operator includes several steps, including many steps that are optional. The basic, necessary steps include setting up the tool 10 around the cable to be cut and using the remote control 110 to initiate the cut. Using the tool 10 may include the following steps:
1.) validate the tool 10 and remote serial numbers match;
2.) check tool 10 and remote control 110 battery power levels;
3.) keep the remote control 110 in the possession of the operator with the power turned off during tool 10 setup and rigging;
4.) setup the tool around the cable to be cut;
5.) rig the tool 10 into position, if necessary;
6.) engage the moving blade 14 into desired position around the cable with the latch 22;
7.) turn the tool 10 power on;
8.) select a gear direction (cut or open);
9.) confirm the moving blade 14 is properly engaged with the LED indicator 44;
10.) operator relocate to a designated safe location with the remote control 110;
11.) turn the remote control 110 power on;
12.) verify that the remote control 110 has properly connected to the tool 10 by the indicator 116 on the remote control 110;
13.) verify that the moving blade 14 is engaged by the indicator 116 on the remote control 110;
14.) depress the two activation buttons 120 at the same time and hold in the depressed condition until the blade engaged indicator 116 turns off;
15.) once operation is complete, release the activation buttons 120 and turn the power off for the remote control 110 prior to reentering the work area.

The foregoing has described a remotely controlled cutting tool 10 with remote control 110 and method of use. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A cutting tool, comprising:
(a) a cutting tool housing;
(b) an electromechanical drive positioned within the cutting tool housing;
(b) a moving blade operatively coupled to the electromechanical drive;
(c) a stationary blade operatively coupled to the cutting tool housing; and
(d) a communication module disposed within the cutting tool housing that wirelessly communicates with a wireless remote control to perform a cutting operation that moves the moving blade to interact with the stationary blade, while the stationary blade remains stationary during the cutting operation.

2. The cutting tool of claim 1, further comprising:
(a) a battery connector; and
(b) a battery positioned within the cutting tool housing and configured to connect to the battery connector and power the cutting tool when connected.

3. The cutting tool of claim 2, wherein the battery is an 18V rechargeable battery.

4. The cutting tool of claim 1, wherein the moving blade and the stationary blade both have concave and cutting surfaces, wherein the moving blade and the stationary blade are aligned to form an enclosed cutting aperture for cutting a cable positioned between the moving blade and the stationary blade during the cutting operation.

5. The cutting tool of claim 1, wherein the cutting tool comprises a plurality of indicators, the plurality of indicators comprising at least one LED indicator configured to indicate a successful pairing with the wireless remote control.

6. The cutting tool of claim 1, wherein the housing further comprises one or more rigging points for securely positioning the cutting tool during use.

7. The cutting tool of claim 1, further comprising:
a sensor configured to detect a position of one of the moving blade and the stationary blade; and
an indicator configured to receive a signal from the sensor and provide an indication the cutting operation was successfully completed.

8. A cutting tool system, comprising:
a remote control configured to wirelessly pair with a cutting tool; and
the cutting tool, comprising:
(a) a cutting tool housing;
(b) an electromechanical drive positioned within the cutting tool housing;
(b) a moving blade operatively coupled to the electromechanical drive;
(c) a stationary blade operatively coupled to the cutting tool housing; and
(d) a communication module for wirelessly communicating with the wireless remote control to perform a cutting operation that moves the moving blade to interact with the stationary blade, while the stationary blade remains stationary during the cutting operation.

9. A cutting system, the cutting system comprising:
(a) a wireless remote control; and
(b) a cutting tool configured to wirelessly pair with the remote control and wirelessly receive transmissions from the remote control, the wireless transmissions activating an electromechanical drive that moves a moving blade, the cutting tool comprising:
(i) a housing;
(ii) an electromechanical drive located within the housing;
(iii) a stationary blade operatively coupled to the housing;
(iii) a moving blade operatively coupled to the electromechanical drive;
(c) wherein the moving blade and the stationary blade are aligned to form an enclosed cutting aperture between the moving blade and the stationary blade during a cutting operation.

10. A cable cutting system of claim 9, wherein the wireless remote control comprises one or more light emitting diode (LED) indicators configured to indicate one or more conditions associated with the cutting tool.

11. The cable cutting system of claim 10, wherein the one or more conditions comprise a successful pairing between the cutting tool and the wireless remote control.

12. A cable cutting system of claim 9, wherein the remote control comprises a plurality of input buttons coupled to a housing of the remote control for initiating the cutting operation.

13. A method for operating a wirelessly remotely controlled cutting tool, the method comprising:
(a) positioning a cable between a moving blade and a stationary blade of the wirelessly remotely controlled cutting tool;
(b) pairing the wirelessly remotely controlled cutting tool to a wireless remote control; and
(c) activating, via the wireless remote control, a cutting operation the activating causing the wireless remote control to communicate with a communication module of the wirelessly remotely controlled cutting tool to activate an electromechanical drive of the wirelessly remotely controlled cutting tool, which in response to causes the electromechanical drive to engage the moving blade such that the moving blade interacts with the stationary blade during the cutting operation to cut the cable positioned between the moving blade and the stationary blade.

14. The method for operating the wirelessly remotely controlled cutting tool of claim 13, wherein the method further comprises securely positioning the tool with rigging by connecting the rigging to rigging points on the wirelessly remotely controlled cutting tool.

15. The method for operating the wirelessly remotely controlled cutting tool of claim 13, wherein completion of the cutting operation initiates a feedback signal from the wirelessly remotely controlled cutting tool to the wireless remote control, the feedback signal causing one or more indicators of the remote control to indicate a status of the cutting operation.

16. The method for operating the wirelessly remotely controlled cutting tool of claim 15, wherein the status of the cutting operation is completion of a cut of the cable.

17. A cutting tool assembly, comprising:
(a) a cutting tool, comprising:
(i) a housing;
(ii) a communication module configured to receive a wireless transmission;
(iii) an electromechanical drive at least partially housed within the housing and electrically coupled to the communication module, the electromechanical drive being configured to operate in response to a signal received from the communication module;
(iv) a moving blade operatively coupled to the electromechanical drive; and
(b) a grounding stud configured to provide a grounding functionality to the cutting tool.

18. The cutting tool assembly of claim 17, further comprising a wireless remote control comprising a remote control communication module configured to pair with the communication module of the cutting tool.

19. The cutting tool assembly of claim 18, wherein the wireless remote control comprises at least one light emitting diode (LED) indicator configured to indicate a successful cutting operation.

20. The cutting tool assembly of claim 17, further comprising a stationary blade configured to engage the moving blade during a cutting operation.

21. A method, comprising:
(a) receiving, by a remote control wirelessly paired to and spatially separated from a cutting tool, an activation input;
(b) transmitting, via a communication module of the remote control and in response to the activation input, one or more control signals to a communication module of the cutting tool, the one or more control signals comprising an activation signal to activate a cutting operation;
(c) receiving, by the remote control, a transmission from the cutting tool, the transmission indicating completion of the cutting operation;
(d) providing, via one or more indicators of the remote control, a visual indication indicating successful completion of the cutting operation.

22. The method of claim 21, further comprising indicating, via the one or more indicators of the remote control, a successful wireless pairing of the remote control with the cutting tool.

23. The method of claim 21, further comprising receiving an engagement signal from the communication module of the cutting tool indicating, via the one or more indicators of the remote control, that a moving blade is properly engage to perform the cutting operation.

24. The method of claim 21, wherein the one or more indicators comprise at least one light emitting diode (LED), wherein the LED is configured to provide the visual indication indicating successful completion of the cutting operation.

25. A method, comprising:
(a) sending, via a communication module of a cutting tool, an indication to a remote control, the indication indicating that the cutting tool is properly paired with the remote control;
(b) receiving, by the communication module of the cutting tool, an activation input;
(c) providing, by the communication module of the cutting tool, a signal to an electromechanical drive of the cutting tool to initiate a cutting operation;
(d) engaging, via the electromechanical drive and as part of the cutting operation, a moving blade of the cutting tool, thereby causing the moving blade to move towards an object positioned in between the moving blade and a stationary blade of the cutting tool;
(e) detecting, via one or more sensors, completion of the cutting operation, the completion of the cutting operation fully cutting through the object; and
(f) transmitting, via the communication module of the cutting tool, a completion signal to the remote control indicating completion of the cutting operation.
